(19) United States
(12) Patent Application Publication
(10) Pub. No.: US 2010/0147654 A1
(43) Pub. Date: Jun. 17, 2010

(54) PRODUCTION LINE

(75) Inventor: CHIA-EN LEE, Shindian (TW)

Correspondence Address: PCE INDUSTRY, INC.;ATT. Steven Reiss, 288 SOUTH MAYO AVENUE, CITY OF INDUSTRY, CA, 91789, US

(73) Assignee: FIH (Hong Kong) Limited, Kowloon (HK)

(21) Appl. No.: 12/512,380

(22) Filed: Jul. 30, 2009

(30) Foreign Application Priority Data
Dec. 11, 2008 (CN) 200810306189.1

(51) Int. Cl. B65G 17/26

(52) U.S. Cl. 198/606

(57) ABSTRACT

A production line used to assemble, test and pack some electronic components comprises an assembly line including a first side board and a first conveyor belt adjacent to the first side board, a testing line including a second side board and a second conveyor belt spaced away from the second side board, and a packing line including a third side board and a third conveyor belt adjacent to the third side board. The assembly line, the testing line, and the packing line are connected together.

### CROSS-REFERENCE TO RELATED APPLICATION

This application is related to co-pending U.S. patent application (Attorney Docket No. US22505, entitled “PRODUCTION LINE”, by CHIA-EN LEE, which is the same assignee as the present application. The above-identified application is incorporated herein by reference.

### BACKGROUND

1. Technical Field

The present disclosure relates to production lines and, particularly, to a production line used to produce portable electronic devices.

2. Description of Related Art

A production line for portable electronic devices typically includes assembling of components in a predetermined order and testing the assembled components after assembly. The production line includes at least an assembly line, a testing line and a packing line.

However, such production lines may be invariable and not satisfy high efficiency and quality productions.

Therefore, there is room for improvement within the art.

### BRIEF DESCRIPTION OF THE DRAWINGS

Many aspects of the production line can be better understood with reference to the following drawings. These drawings are not necessarily drawn to scale, the emphasis instead being placed upon clearly illustrating the principles of the present production line. Moreover, in the drawings like reference numerals designate corresponding sections throughout the several views.

FIG. 1 is a schematic view of a production line, in accordance with an exemplary embodiment.

FIG. 2 is a side view of a assembly line shown in FIG. 1.

FIG. 3 is a side view of a testing line shown in FIG. 1.

FIG. 4 is a side view of a packing line shown in FIG. 1.

FIG. 5 is a cross-sectional view of a connecting member shown in FIG. 1, taken along line V-V

### DETAILED DESCRIPTION

The present production line is suitable for producing electronic devices, e.g., mobile phones and personal digital assistants (PDAs).

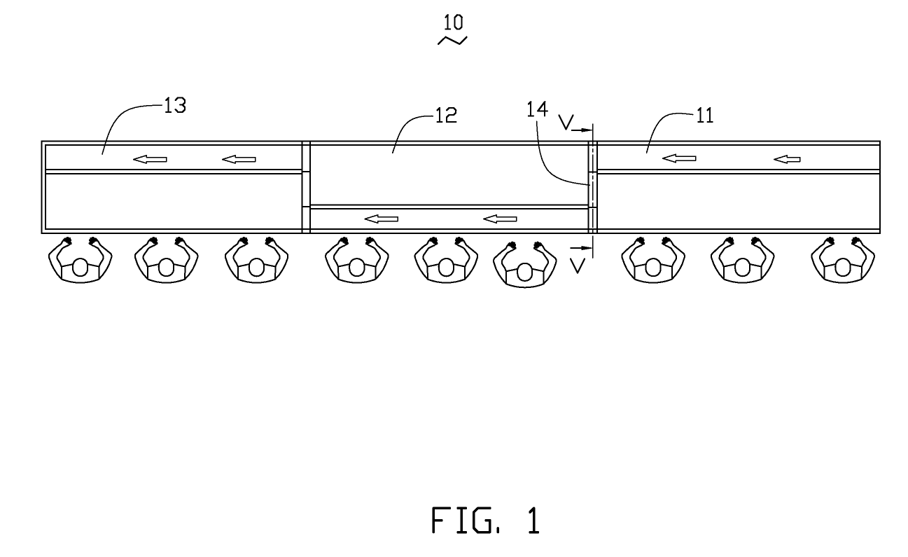

FIG. 1 shows an exemplary production line 10, the production line 10 includes an assembly line 11, a testing line 12, a packing line 13, and two connecting members 14. The assembly line 11, the testing line 12, and the packing line 13 are connected together by the two connecting members 14.

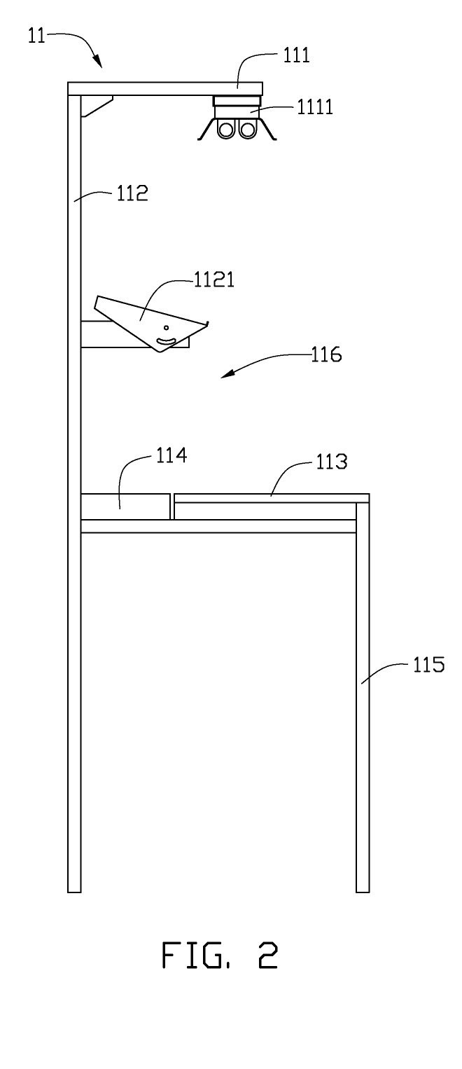

Referring to FIG. 2, the assembly line 11 includes a first top board 111, a first side board 112, a first working platform 113, a first conveyor belt 114, and a plurality of first support legs 115. The first top board 111 and the first working platform 113 are respectively mounted to the first side board 112. The first conveyor belt 114 is located between the first working platform 113 and the first side board 112. The first working platform 113 includes an anti-static film (not shown) to reduce electrostatic discharge damage on electronic components. The first support legs 115 are fastened to a periphery of the first working platform 113, used to support the first assembly line 11. The first top board 111 includes a lamp 1111, used to provide light to the assembly line 11. The first side board 112 includes a material platform 1121 protruding therefrom towards the first working platform 113, used to hold assembly materials. The first top board 111, the first side board 112 and the first working platform 113 partially enclose an assembly operating space 116. The assembly operating space 116 is for an operator to conduct assembly on electronic components, e.g., a liquid crystal display (LCD). The assembly operating space 116 can have anti-static film (not shown) coated therein, thus facilitating cleanliness during assembly process.

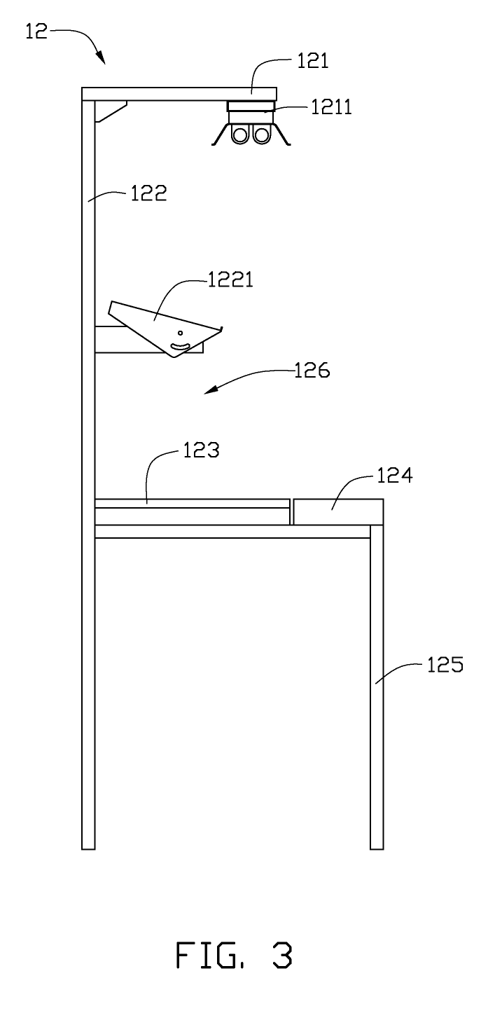

Referring to FIG. 3, the testing line 12 includes a second top board 121, a second side board 122, a second working platform 123, a second conveyor belt 124, and a plurality of second support legs 125. The second top board 121 and the second working platform 123 are respectively mounted to the second side board 122. The second working platform 123 is located between the second conveyor belt 124 and the second side board 122. The second working platform 123 is used to hold testing devices (not shown). The second support legs 125 are fastened to a periphery of the second working platform 123, used to support the testing line 12. The height of the second support legs 125 is less than the height of the first support legs 115. The second top board 121 includes a lamp 1211, used to provide light to the testing line 12. The second side board 122 includes a material platform 1221 protruding therefrom towards the second conveyor belt 124, used to hold testing materials. The second top board 121, the second side board 122 and the second working platform 123 partially enclose a testing space 136. The testing space 136 is for an operator to conduct testing on electronic components, e.g., to judge whether an LCD for any visual defects.

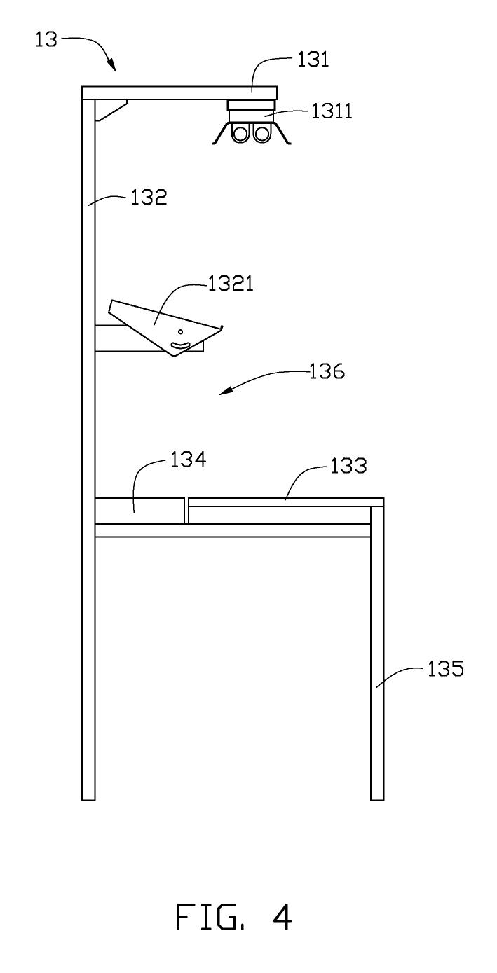

Referring to FIG. 4, the packing line 13 includes a third top board 131, a third side board 132, a third working platform 133, a third conveyor belt 134, and a plurality of third support legs 135. The third top board 131 and the third working platform 133 are respectively mounted to the third side board 132. The third conveyor belt 134 is located between the third working platform 133 and the third side board 132. The third working platform 133 includes an anti-static film (not shown) to reduce electromagnetic discharge damage on electronic components. The third support legs 135 are fastened to a periphery of the third working platform 133, used to support the packing line 13. The height of the third support legs 135 is less than the height of the second support legs 125. The third top board 131 includes a lamp 1311, used to provide light to the packing line 13. The third side board 132 includes a material platform 1321 protruding therefrom towards the third working platform 133, used to hold packing materials. The third top board 131, the third side board 132 and the third working platform 133 partially enclose a packing space 136.

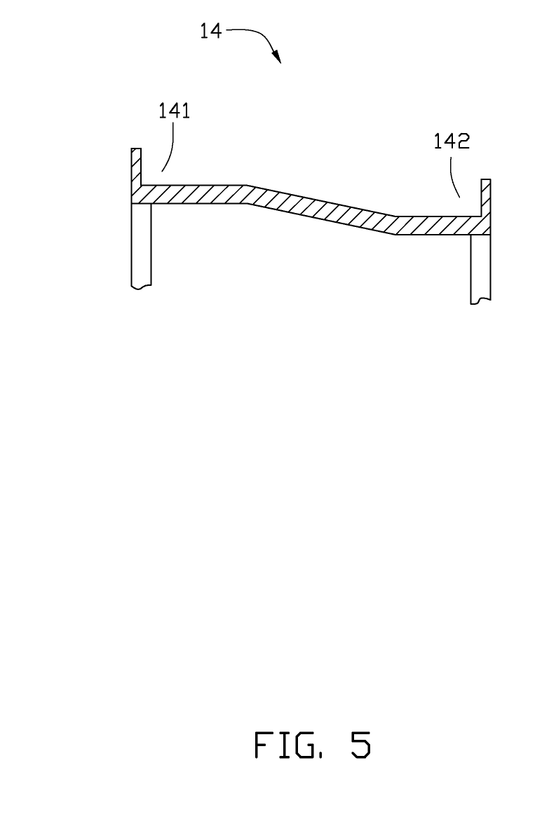

Referring to FIG. 5, the connecting member 14 defines a slide with an inlet 141 and an outlet 142 opposite to the inlet 141. The inlet 141 communicates with one conveyor belt, and the outlet 142 communicates with another conveyor belt, thus conveying electronic components between the assembly line 11, the testing line 12, and the packing line 13.

In assembly, the assembly line 11, the testing line 12, and the packing line 13 are located adjacent to each other. One connecting member 14 is positioned between the assembly line 11 and the testing line 12, and the inlet 141 communicates with the first conveyor belt 114, the outlet 142 communicates with one end of the second conveyor belt 124. Then the other connecting member 14 is positioned between the testing line 12 and the packing line 13, and the inlet 141 communicates with the other end of the second conveyor belt 124, and the outlet 142 communicates with the third conveyor belt 134. Thus, the assembly line 11, the testing line 12 and the packing line 13 are connected together in series.

In use, the first conveyor belt 114, the second conveyor belt 124, and the third conveyor belt 134 are triggered to move. Operators sit adjacent to the first working platform 113, the second working platform 123, and the third working platform 113, facing the first side board 112, the second side board 122, and the third side board 132. The operators first assemble electronic components to form an electronic device, then test the electronic device on the testing line 12, and finally packaging the electronic device on the packing line 13.

The first conveyor belt 114 of the assembly line 11 and the third conveyor belt 134 are located adjacent their respective side boards, thus, an operator can place their hands on the working platforms 113, 133, alleviating operator fatigue and improving assembly efficiency and packing efficiency. The second conveyor belt 124 is far from the second side board 122, so that testing devices can be located between the second conveyor belt 124 and the second side board 122, shortening the distance between the testing devices and the second conveyor belt 124 and improving testing efficiency.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of sections within the principles of the disclosure to the full extent indicated by the broad general meaning of the terms, in which the appended claims are expressed.

What is claimed is:

1. A production line used to assemble, test and pack electronic components comprising:
an assembly line including a first side board and a first conveyor belt adjacent to the first side board;
a testing line including a second side board and a second conveyor belt spaced away from the second side board; and
a packing line including a third side board and a third conveyor belt adjacent to the third side board, the assembly line, the testing line, and the packing line connected together.

2. The production line as claimed in claim 1, further comprising two connecting members, wherein one connecting member is used to connect the assembly line and the testing line, the other is used to connect the testing line and the packing line.

3. The production line as claimed in claim 1, wherein the assembly line further includes a first top board, and a first working platform, the first top board and the first working platform are respectively mounted to the first side board, the first conveyor belt is located between the first working platform and the first side board.

4. The production line as claimed in claim 3, wherein the assembly line further includes a plurality of first support legs, the first support legs are fastened to a periphery of the first working platform, used to support the first assembly line.

5. The production line as claimed in claim 3, wherein the first side board includes a material platform protruding therefrom towards the first conveyor belt, used to place some assembly materials.

6. The production line as claimed in claim 3, wherein the first top board, the first side board and the first working platform define an assembly operating space.

7. The production line as claimed in claim 1, wherein the testing line further includes a second top board, a second side board, a second working platform, and a second conveyor belt, the second top board and the second working platform are respectively mounted to the second side board, the second working platform is located between the second conveyor belt and the second side board.

8. The production line as claimed in claim 7, wherein the assembly line further includes a plurality of first support legs, used to support the first assembly line, the testing line further includes a plurality of second support legs, the second support legs are fastened to a periphery of the second working platform, used to support the testing line, the height of the second support legs is less than the height of the first support legs.

9. The production line as claimed in claim 7, wherein the second top board includes a lamp formed thereon.

10. The production line as claimed in claim 7, wherein the second side board includes a material platform protruding therefrom towards the second conveyor belt, used to place some testing materials.

11. The production line as claimed in claim 7, wherein the second top board, the second side board and the second working platform surround a testing space.

12. The production line as claimed in claim 1, wherein the packing line further includes a third top board, and a third working platform, the third top board and the third working platform are respectively mounted to the third side board, the third conveyor belt is located between the third working platform and the third side board.

13. The production line as claimed in claim 7, wherein the testing line further includes a plurality of second support legs, the second support legs are fastened to a periphery of the second working platform, used to support the testing line, the packing line further includes a plurality of third support legs, used to support the packing line, the height of the third support legs is less than the height of the second support legs.

14. The production line as claimed in claim 12, wherein the third top board includes a lamp formed thereon.

15. The production line as claimed in claim 12, wherein the third side board includes a material platform protruding therefrom towards the first conveyor belt, used to place some packing materials.

16. The production line as claimed in claim 12, wherein the third top board, the third side board and the third working platform define a packing space.
